(19) United States
(12) Patent Application Publication
(10) Pub. No.: US 2010/0164885 A1
(43) Pub. Date: Jul. 1, 2010

(54) DISPLAY DEVICE PROVIDED WITH TOUCH PANEL AND METHOD FOR MANUFACTURING THE DISPLAY DEVICE

(76) Inventor: Hideo Hosorogi, Osaka (JP)

Correspondence Address: BIRCH STEWART KOLASCH & BIRCH, PO BOX 747, FALLS CHURCH, VA, 22040-0747, US

(21) Appl. No.: 12/601,905

(22) PCT Filed: Aug. 8, 2008
(86) PCT No.: PCT/JP2008/002185

§ 371 Date: Nov. 25, 2009

(30) Foreign Application Priority Data
Sep. 7, 2007 (JP) 2007-233104

(51) Int. Cl. G06F 3/041; H01J 9/00

(52) U.S. Cl. 345/173; 445/24

(57) ABSTRACT

In a touch panel display device, adhesive means is formed by a plurality of strip-shaped members, which are provided between a display device and a touch panel so as to extend along the peripheries thereof, and so that at least a pair of adjoining ones of the members are arranged with a gap being interposed therebetween, where the gap has a bent portion.

### TECHNICAL FIELD

The present disclosure relates to display devices provided with a touch panel (hereinafter referred to as the “touch panel display devices”), and manufacturing methods thereof.

### BACKGROUND ART

As disclosed in Patent Document 1, Patent Document 2, and the like, touch panels, which are attached to liquid crystal display (LCD) devices, plasma display devices, and the like, are typically bonded to rectangular display devices, which serve as a base, by adhesive means provided in the peripheries of the display devices.

In this case, as an example of the adhesive means, as shown in FIG. 10, a plurality of frame-shaped double-sided tapes 102 are prepared by removing respective middle parts 101 from a sheet-like double-sided tape 100, and as shown in FIG. 11, each frame-shaped double-sided tape 102 is placed on the periphery of a display device 103.

As another example of the adhesive means, as shown in FIG. 12, four strip-shaped double-sided tapes 104 are prepared, and placed on each side of the periphery of a display device 105.

PATENT DOCUMENT 1: Japanese Published Patent Application No. 2000-293309

PATENT DOCUMENT 2: Japanese Published Patent Application No. 2004-191782

### SUMMARY OF THE INVENTION

### Technical Problem

However, in the adhesive means as shown in FIG. 11, only the frame portion 102 is actually used in the manufacturing process, and the removed middle part 101 is sometimes discarded without being used as the adhesive means. This increases the manufacturing cost.

Moreover, in the adhesive means as shown in FIG. 12, the strip-shaped double-sided tapes 104 are placed on the periphery of the display device 105, where adjoining ones of the strip-shaped double-sided tapes 104 are positioned with a predetermined gap 106 therebetween, in order to prevent the adjoining strip-shaped double-sided tapes 104 from overlapping each other, and due to accuracy limitations of the manufacturing process, and the like. In this case, as shown in FIG. 13, each strip-shaped double-sided tape 104 is formed to have linear ends, and thus, the gap 106 is also formed linearly. Thus, foreign matter 107 tends to enter the device from the outside, which may reduce the device quality.

### Solution to the Problem

The present invention was developed in view of the above problems, and it is an object of the present invention to provide a touch panel display device capable of preventing reduction in quality, and capable of being manufactured at low cost, and a manufacturing method thereof.

A touch panel display device according to the present invention includes a display device and a touch panel, which are positioned so as to face each other, where the display device and the touch panel are bonded together along peripheries thereof by adhesive means, wherein the adhesive means is formed by a plurality of strip-shaped members, which are provided between the display device and the touch panel so as to extend along the peripheries thereof, and so that at least a pair of adjoining ones of the members are arranged with a gap being interposed therebetween, where the gap has a bent portion.

According to this structure, the adhesive means is formed by the plurality of strip-shaped members, which are provided between the display device and the touch panel so as to extend along the peripheries thereof. Thus, it is not necessary to remove a middle part of the adhesive means in the manufacturing process in order to provide the adhesive means between the display device and the touch panel, in a frame pattern in the peripheries of the display device and the touch panel. Thus, the entire adhesive means can be used efficiently. This can reduce the manufacturing cost of the touch panel display device.

Moreover, since at least a pair of adjoining ones of the plurality of strip-shaped members are arranged with the gap being interposed therebetween, and the gap has the bent portion, the bent portion serves as an obstacle to foreign matter passing through the gap of the adhesive means, whereby the foreign matter can be prevented from entering the touch panel display device from the outside. This can prevent reduction in quality of the touch panel display device in a desirable manner. Moreover, since the bent portion, provided in the gap of the adhesive means, serves as alignment means when positioning and bonding the display device and the touch panel, no additional separate alignment means need be formed, thereby improving manufacturing efficiency of the touch panel display device.

Moreover, in the touch panel display device of the present invention, multiple ones of the bent portion may be formed in the gap.

According to this structure, since multiple ones of the bent portion are formed in each gap, the number of obstacles to the foreign material passing through each gap is increased. Thus, the foreign matter can be prevented from entering the touch panel display device from the outside in a more desirable manner.

Moreover, in the touch panel display device of the present invention, in the plurality of strip-shaped members of the adhesive means, an end of one of the adjoining members may be formed as a male end, and an end of the other member may be formed as a female end, and the male end of the strip-shaped member may be positioned so as to be fitted into the female end of the strip-shaped member, thereby forming the gap having the multiple ones of the bent portion.

According to this structure, in the plurality of strip-shaped members of the adhesive means, an end of one of the adjoining members is formed as a male end, and an end of the other member is formed as a female end, and the male end of the strip-shaped member is positioned so as to be fitted into the female end of the strip-shaped member, thereby forming the gap having the multiple ones of the bent portion. This can make the path of the foreign matter in the gap more complex without reducing the area where the adhesive means is positioned. Thus, the foreign matter can be prevented from entering the touch panel display device from the outside in a more desirable manner, while maintaining desirable bonding strength of the adhesive means.

Moreover, in the touch panel display of the present invention, the gap having the bent portion may be provided between every adjoining ones of the strip-shaped members.

According to this structure, since the gap having the bent portion is provided between every adjoining ones of the strip-shaped members, the foreign matter can be prevented from entering the touch panel display device from the outside in a more desirable manner

Moreover, in the touch panel display device of the present invention, the adhesive means may be a double-sided tape.

According to this structure, since the adhesive means is a double-sided tape, the strip-shaped members, and the bending portion in the ends of the strip-shaped members can be easily formed at low cost.

A method for manufacturing a touch panel display device according to the present invention includes the steps of: preparing a display device and a touch panel; providing adhesive means, which is formed by a plurality of strip-shaped members, between the display device and the touch panel so as to extend along peripheries thereof, and so that at least a pair of adjoining ones of the members are arranged with a gap being interposed therebetween, where the gap has a bent portion; and bonding the display device and the touch panel together by the adhesive means.

According to this structure, the adhesive means is formed by the plurality of strip-shaped members, which are provided between the display device and the touch panel so as to extend along the peripheries thereof. Thus, it is not necessary to remove a middle part of the adhesive means in the manufacturing process in order to provide the adhesive means between the display device and the touch panel, in a frame pattern in the peripheries of the display device and the touch panel. Thus, the entire adhesive means can be used efficiently. This can reduce the manufacturing cost of the touch panel display device.

Moreover, since at least a pair of adjoining ones of the plurality of strip-shaped members are arranged with the gap being interposed therebetween, and the gap has the bent portion, the bent portion serves as an obstacle to foreign matter passing through the gap of the adhesive means, whereby the foreign matter can be prevented from entering the touch panel display device from the outside. This can prevent reduction in quality of the touch panel display device in a desirable manner. Moreover, since the bent portion, provided in the gap of the adhesive means, serves as alignment means when positioning and bonding the display device and the touch panel, no additional separate alignment means need be formed, thereby improving manufacturing efficiency of the touch panel display device.

### Advantages of the Invention

A touch panel display device capable of preventing reduction in quality, and capable of being manufactured at low cost, and a manufacturing method thereof can be provided according to the present invention.

### BRIEF DESCRIPTION OF THE DRAWINGS

FIG. 1 is a schematic exploded view showing individual components of a touch panel LCD device according to an embodiment of the present invention.

FIG. 2 is a plan view showing a state where a double-sided tape according to the embodiment of the present invention is positioned.

FIG. 3 is an enlarged view of the ends of strip-shaped members of the double-sided tape according to the embodiment of the present invention.

FIG. 4 is an enlarged view of the ends of strip-shaped members of a double-sided tape according to another embodiment of the present invention.

FIG. 5 is an enlarged view of the ends of strip-shaped members of a double-sided tape according to still another embodiment of the present invention.

FIG. 6 is an enlarged view of the ends of strip-shaped members of a double-sided tape according to yet another embodiment of the present invention.

FIG. 7 is an enlarged view of the ends of strip-shaped members of a double-sided tape according to a further embodiment of the present invention.

FIG. 8 is an enlarged view of the ends of strip-shaped members of a double-sided tape according to a still further embodiment of the present invention.

FIG. 9 is an enlarged view of the ends of strip-shaped members of a double-sided tape according to a yet further embodiment of the present invention.

FIG. 10 is a plan view showing a sheet-like double-sided tape, and a plurality of frame-shaped double-sided tapes that are formed from the double-sided tape.

FIG. 11 is a plan view showing a frame-shaped double-sided tape provided in the periphery of a display device.

FIG. 12 is a plan view of strip-shaped double-sided tapes provided on each side of the periphery of a display device.

FIG. 13 is an enlarged view of the ends of strip-shaped double-sided tapes provided in the periphery of a display device.

### DESCRIPTION OF REFERENCE CHARACTERS

Touch Panel LCD Device
11 Touch Panel
12 LCD Device
13, 43, 53, 63, 73, 83, 93 Double-Sided Tape
21-24, 41-42, 51-52, 61-62, 71-72, 81-82, 91-92 Strip-Shaped Member
25, 45, 55, 65, 75, 85, 95 Bent Portion
26, 46, 56, 66, 76, 86, 96 Gap

### Description of Embodiments

Although embodiments of the present invention will be described in detail below with reference to the accompanying drawings, the present invention is not limited to these embodiments.

### Embodiments

A touch panel display device according to an embodiment will be described in detail with reference to the figures. An LCD device provided with a touch panel (hereinafter referred to as the “touch panel LCD device”) will be described herein as an example of the touch panel display device.

(Structure of a Touch Panel LCD Device 10)

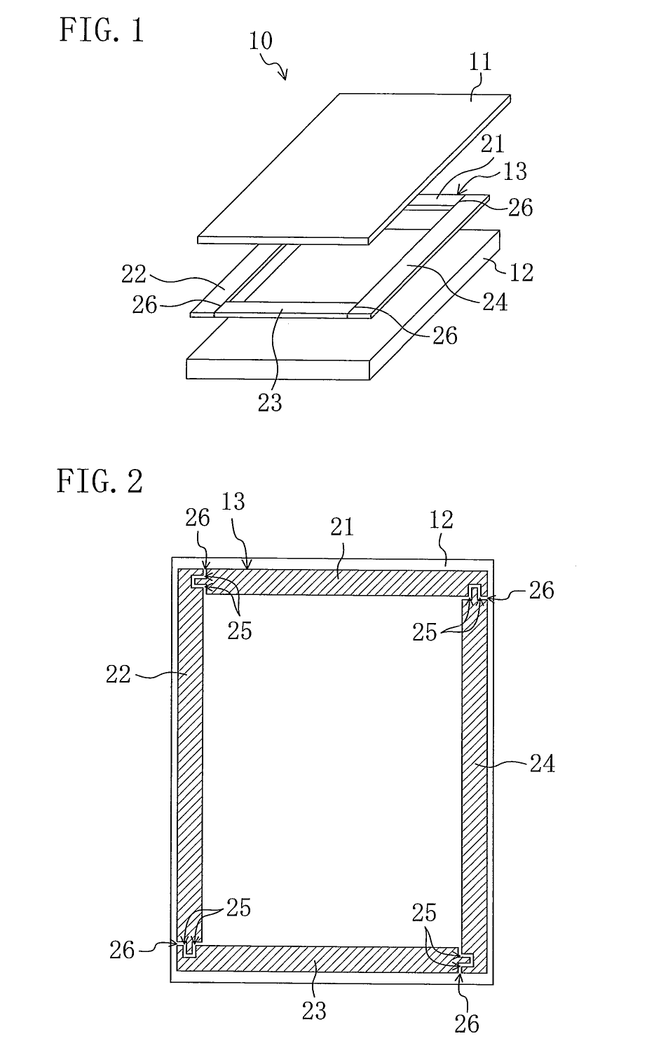

FIG. 1 is a schematic exploded view showing individual components of a touch panel LCD device 10 according to an embodiment of the present invention.

An LCD device 12 is formed by a case, which covers an LCD panel and a backlight positioned on the back surface of the LCD panel. A touch panel 11 is placed on the front surface of the LCD device 12, and is bonded with a front case of the LCD device 12 by a double-sided tape 13 (adhesive means).

Although any type of touch panel may be used, the touch panel 11 is formed by, e.g., an insulating substrate, a panel in-plane electrode formed on the insulating substrate, frame wirings disposed on the four sides of the panel in-plane electrode so as to form a frame, and outer wirings formed on the insulating substrate, and electrically connected to the four corners of the panel in-plane electrode to serve as current detecting means.

Although any type of LCD panel may be used, the LCD panel has, e.g., a TFT substrate having a glass substrate, and a CF (color filter) substrate having a color filter formed thereon and having a glass substrate, where a liquid crystal layer and spacers (both of which are not shown) are provided between the TFT substrate and the CF substrate, and a polarizer, an FPC (flexible printed circuit), and a driver are provided (all of which are not shown).

As shown in FIG. 2, the double-sided tape 13 is formed by four strip-shaped members 21 through 24, and is provided so that the four strip-shaped members 21 through 24 extend between the LCD panel and the touch panel 11 along the respective peripheries of the LCD panel and the touch panel 11. The four strip-shaped members 21 through 24 of the double-sided tape 13 are arranged with a gap 26 being interposed between adjoining ones of the members (the strip-shaped members 21 and 22, 22 and 23, 23 and 24, and 24 and 21 in FIG. 1), where the gap 26 has bent portions 25.

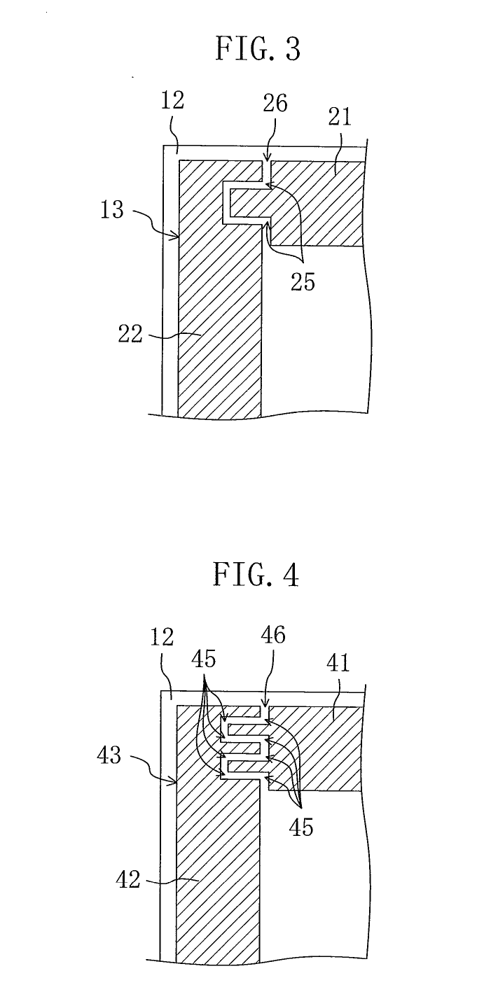

In these adjoining members, as shown in FIG. 3, an end of one of the adjoining members (an end of the strip-shaped member 21 in FIG. 3) is formed as a male end, an end of the other member (an end of the strip-shaped member 22 in FIG. 3) is formed as a female end, and the male end is positioned so as to be fitted into the female end, thereby forming a gap 26 having bent portions 25. In the strip-shaped members 21 through 24 of the present embodiment, since one of adjoining members is formed as a protruding member (a male member), and the other member is formed as a recessed member (a female member), each gap 26 has four bent portions 25. The gap 26 having such bent portions 25 is provided between every adjoining ones of the strip-shaped members 21 through 24.

The thickness of the strip-shaped members 21 through 24 of the double-sided tape 13 is, e.g., about 50 μm to about 100 μm. The width of the strip-shaped members 21 through 24 of the double-sided tape 13 is, e.g., about 1 mm to about 5 mm, although it depends on the size of the LCD panel 12 and the touch panel 11. The width of the gaps 26 formed between the strip-shaped members 21 through 24 of the double-sided tape 13 is, e.g., about 0.1 mm to about 0.2 mm.

Each strip-shaped member 21 through 24 of the double-sided tape 13 is formed by a tape base material, and adhesive layers formed on both surfaces of the tape base material.

For example, a PET (polyethylene terephthalate) film, an acrylic film, a vinyl chloride film, a fluorine film, a polyolefin film, an acrylic copolymer film such as an acrylonitrile-butadiene-styrene copolymer resin (an ABS resin), a polycarbonate film, a polyurethane film, and the like can be used as the tape base material. As a technique of further suppressing discoloration due to UV exposure, an UV (ultraviolet) absorber may be applied to these materials of the tape base material, or the tape base material may be impregnated with the UV absorber.

For example, adhesives, such as a rubber adhesive, an acrylic adhesive, a urethane adhesive, and a silicone adhesive, and the like can be used as an adhesive of the adhesion layers. Of these adhesives, an acrylic adhesive is preferable since it provides a good balance between cost effectiveness and resistance to UV degradation.

The adhesive layers may contain a UV absorber and a photostabilizer. For example, materials, such as a benzophenone material, a benzotriazole material, an oxalic anilide material, a cyanoacrylate material, a triazine material, a salicylate material, and a benzoate material, and the like can be used as the UV absorber, although the UV absorber is not specifically limited to these materials.

Note that the double-sided tape of the present invention is not limited to the shape described above, but may have a shape as shown in FIG. 4. In a double-sided tape 43 of FIG. 4, two protruding portions are formed in a male end of a strip-shaped member 41, and two recessed portions are formed in a female end of a strip-shaped member 42. This male end is positioned so as to be fitted into the female end, thereby forming a gap 46 having eight bent portions 45.

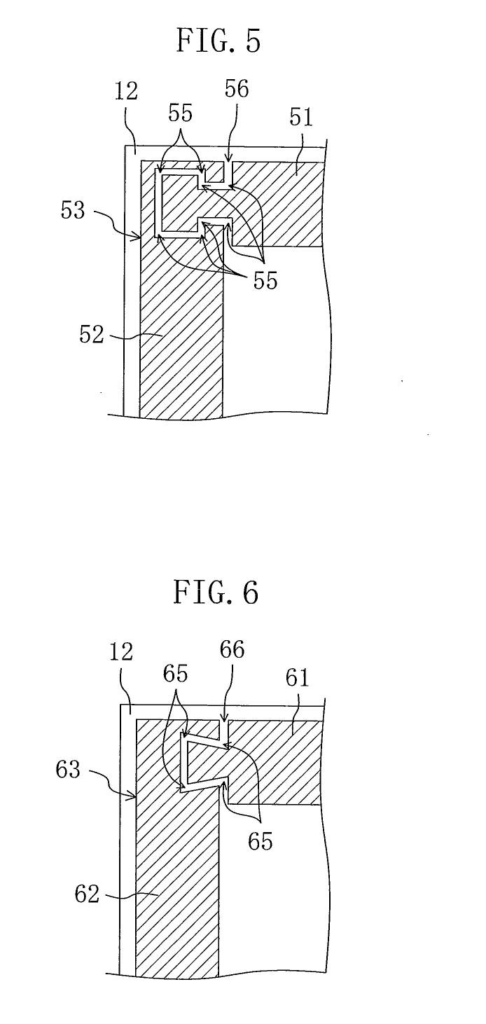

Moreover, the double-sided tape may have a shape as shown in FIG. 5. In a double-sided tape 53 of FIG. 5, a head-like protruding portion, formed by a narrow neck portion and a wide head portion, is formed in a male end of a strip-shaped member 51. A recessed portion corresponding to the head-like protruding portion is formed in a female end of a strip-shaped member 52. This male end is positioned so as to be fitted into the female end, thereby forming a gap 56 having eight bent portions 55.

Moreover, the double-sided tape may have a shape as shown in FIG. 6. In a double-sided tape 63 of FIG. 6, a protruding portion, which widens from its base end toward its tip, is formed in a male end of a strip-shaped member 61. A recessed portion corresponding to this protruding portion is formed in a female end of a strip-shaped member 62. This male end is positioned so as to be fitted into the female end, thereby forming a gap 66 having four bent portions 65.

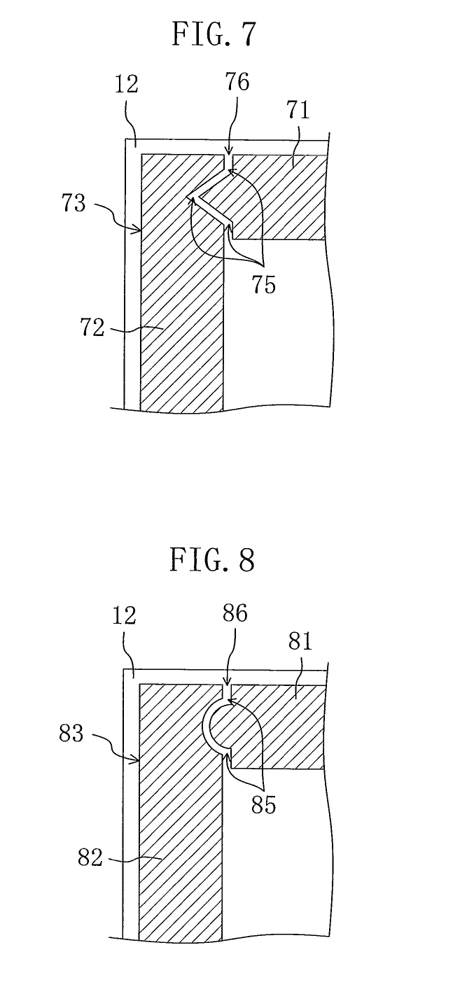

Moreover, the double-sided tape may have a shape as shown in FIG. 7. In a double-sided tape 73 of FIG. 7, a protruding portion, which narrows from its base end toward its tip, is formed in a male end of a strip-shaped member 71. A recessed portion corresponding to this protruding portion is formed in a female end of a strip-shaped member 72. This male end is positioned so as to be fitted into the female end, thereby forming a gap 76 having three bent portions 75.

Moreover, the double-sided tape may have a shape as shown in FIG. 8. In a double-sided tape 83 of FIG. 8, a substantially semicircular protruding portion is formed in a male end of a strip-shaped member 81. A recessed portion corresponding to this protruding portion is formed in a female end of a strip-shaped member 82. This male end is positioned so as to be fitted into the female end, thereby forming a gap 86 having two bent portions 85.

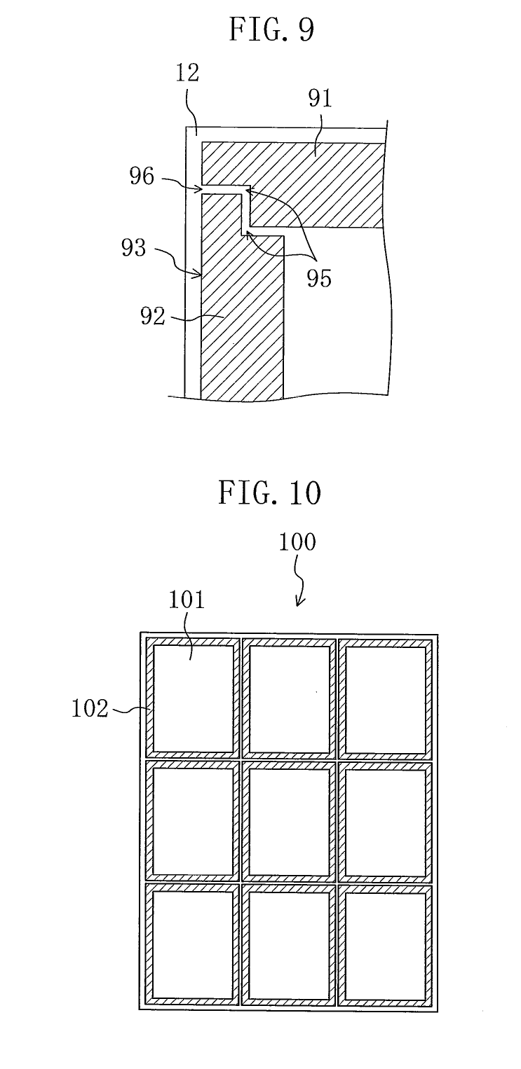

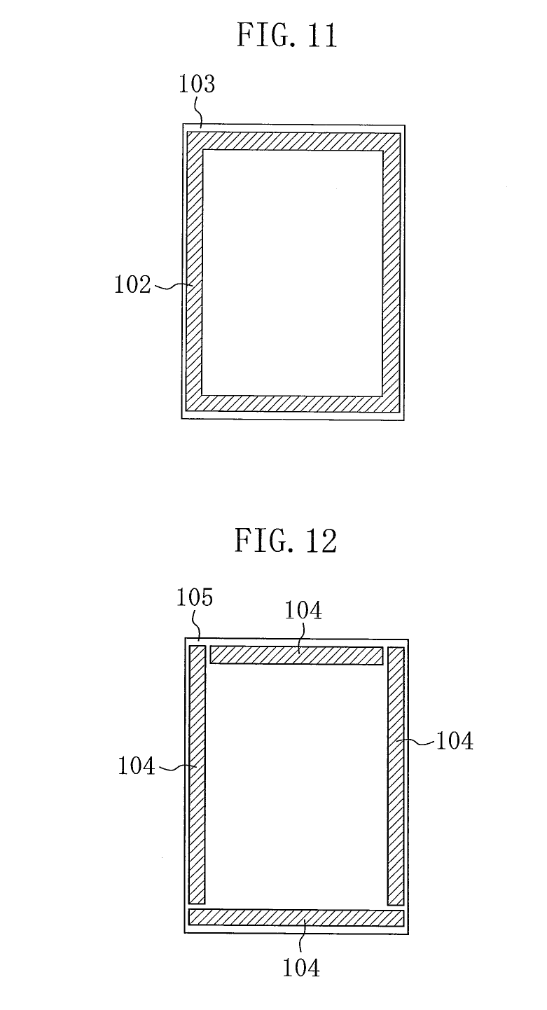

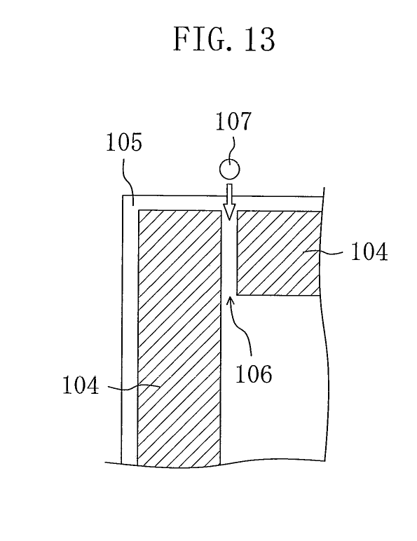

Moreover, the double-sided tape may have a shape as shown in FIG. 9. In a double-sided tape 93 of FIG. 9, each end of strip-shaped members 91, 92 is formed so that only a half on one side of the end in a thickness direction of the strip-shaped members 91, 92 protrudes, and each end of the strip-shaped members 91, 92 has a protruding portion and a recessed portion. In the double-sided tape 93, the protruding portion formed in the end of one strip-shaped member 92 of adjoining members is positioned so as to be fitted into the recessed portion formed in the end of the other strip-shaped member 91, thereby forming a gap 96 having two bent portions 95.

In the above embodiments, the double-sided tape 13 is formed by four strip-shaped members along each side of the respective peripheries of the LCD device 12 and the touch panel 11. However, the double-sided tape 13 need not necessarily be formed by four strip-shaped members. More specifically, the double-sided tape 13 may be formed by four or more strip-shaped members by arranging a plurality of strip-shaped members in series along each side of the respective peripheries of the rectangular LCD device 12 and the rectangular touch panel 11. Moreover, even if the LCD device 12 and the touch panel 11 have a shape other than the rectangular shape (e.g., a triangular shape or other polygonal shape), the double-sided tape 13 may be formed by a plurality of strip-shaped members, including, but not limited to four, when the double-sided tape 13 is provided along the peripheries of the LCD device 12 and the touch panel 11.

Moreover, although the double-sided tape 13, which is formed by the tape base member, and the adhesive layers respectively formed on both surfaces of the tape base material, is used as the adhesive means in the present embodiments, the present invention is not limited to this, and an adhesive sheet, made of a single adhesive resin layer, may be divided into a plurality of strip-shaped adhesive sheets, and these strip-shaped adhesive sheets may be used as the adhesive means.

(Manufacturing Method of the Touch Panel LCD Device 10)

Next, a method for manufacturing the touch panel LCD device 10 will be described.

(Step of Manufacturing the Touch Panel 11)

Typically, a film having an ITO (Indium Tin Oxide) film is patterned by an etching method, and an ITO film on the film is patterned. Then, an electrode pattern and an insulating pattern are formed by a screen printing method by using silver ink and insulating ink. Similarly, a glass having an ITO film is also subjected to an etching process and a patterning process. Note that the glass is subjected also to a patterning process for printing spacers.

Then, the film and the glass are bonded together in their outer peripheries by using an adhesive material. At this time, an FPC for electrical connection to the outside is also connected, whereby the touch panel 11 is manufactured.

(Step of Manufacturing the LCD Panel 12)

First, a glass substrate is prepared, and a light-shielding portion, such as a black matrix, is formed, and then, color layers are formed in a display region. Then, a metal conductive film, such as ITO, is vapor deposited on the color layers to form a counter electrode, and then, an alignment film is formed, thereby fabricating a CF substrate.

Next, a glass substrate is prepared, and thin film transistors (TFTs) are formed. Then, an ITO is deposited by a vacuum deposition process, and is patterned to form pixel electrodes. Then, spacers for defining the cell thickness are formed, thereby fabricating a TFT substrate.

Then, a sealant is continuously applied, with no gap, to the light-shielding portion of the TFT substrate, and a liquid crystal material is dropped onto the TFT substrate by using a dispenser or the like. Then, the CF substrate is aligned with the TFT substrate having the liquid crystal material dropped thereon, and the CF substrate and the TFT substrate are bonded together, thereby fabricating the LCD panel 12.

(Step of Bonding the Touch Panel 11 and the LCD Device 12)

First, a sheet-like double-sided tape 13 is prepared, and is cut into a plurality of strip-shaped members 21 through 24. A protruding portion or a recessed portion is formed in each end of the strip-shaped members 21 through 24.

Then, the prepared strip-shaped members 21 through 24 are positioned so as to extend along the periphery of the surface of the front case of the LCD device 12. At this time, the strip-shaped members 21 through 24 are positioned so that a male end of one of every adjoining members is fitted into a female end of the other member, thereby forming a gap 26 having bent portions 25.

Then, the touch panel 11 is accurately bonded with the LCD panel 12 by using the protruding portions and the recessed portions, which are formed in the ends of the strip-shaped members 21 through 24 of the double-sided tape 13 positioned on the LCD device 12, as positioning alignment means.

Then, the double-sided tape 13 is pressed or the like to firmly bond the touch panel 11 and the LCD device 12 together.

Then, a drive circuit of the touch panel 11 and an FPC of the LCD device 12 are electrically connected to each other.

The LCD device 12 is formed by incorporating a BL (backlight) and a case into an LCD panel provided with a polarizer, an FPC, and a driver. The touch panel LCD device 10 is completed by bonding the touch panel 11 with the LCD device 12.

Note that, although an LCD device was shown as an example of the display device in the present embodiment, the present invention is not limited to this, and the present invention is applicable also to other display devices having a PD (plasma display), a PALC (plasma addressed liquid crystal display), an organic EL (electro luminescence) display, an inorganic EL (electro luminescence) display, an FED (field emission display), an SED (surface-conduction electron-emitter display), or the like.

(Functions and Effects)

Next, functions and effects will be described.

The touch panel LCD device 10 according to the embodiments of the present invention is the touch panel LCD device 10 including the LCD device 12 and the touch panel 11, which are positioned so as to face each other, where the LCD device 12 and the touch panel 11 are bonded with each other along the peripheries thereof by the double-sided tape 13, wherein the double-sided tape 13 is formed by the plurality of strip-shaped members 21 through 24, which are provided between the LCD device 12 and the touch panel 11 so as to extend along the peripheries thereof, and so that at least a pair of adjoining ones of the members are arranged with a gap 26 being interposed therebetween, where the gap 26 has bent portions 25.

According to this structure, the double-sided tape 13 is formed by the plurality of strip-shaped members 21 through 24, which are provided between the LCD device 12 and the touch panel 11 so as to extend along the peripheries thereof. Thus, it is not necessary to remove the middle part of the sheet-like double-sided tape 13 in the manufacturing process in order to provide the double-sided tape 13 between the LCD device 12 and the touch panel 11, in a frame pattern in the peripheries of the LCD device 12 and the touch panel 11. Thus, the entire sheet-like double-sided tape 13 can be used efficiently. This can reduce the manufacturing cost of the touch panel LCD device 10.

Moreover, since at least a pair of adjoining ones of the plurality of strip-shaped members 21 through 24 are arranged with the gap 26 being interposed therebetween, and the gap 26 has the bent portions 25, the bent portions 25 serve as an obstacle to foreign matter passing through the gaps 26 of the double-sided tape 13, whereby the foreign matter can be prevented from entering the touch panel LCD device 10 from the outside. This can prevent reduction in quality of the touch panel LCD device 10 in a desirable manner Moreover, since the bent portions 25 provided in the gaps 26 of the double-sided tape 13 serve as alignment means when positioning and bonding the LCD device 12 and the touch panel 11, no additional separate alignment means need be formed, thereby improving manufacturing efficiency of the touch panel LCD device 10.

### INDUSTRIAL APPLICABILITY

As described above, the present invention relates to touch panel display devices and manufacturing methods thereof.

1. A touch panel display device, comprising:
a display device and a touch panel, which are positioned so as to face each other, where the display device and the touch panel are bonded together along peripheries thereof by adhesive means, wherein
the adhesive means is formed by a plurality of strip-shaped members, which are provided between the display device and the touch panel so as to extend along the peripheries thereof, and so that at least a pair of adjoining ones of the members are arranged with a gap being interposed therebetween, where the gap has a bent portion.

2. The touch panel display device of claim 1, wherein
multiple ones of the bent portion are formed in the gap.

3. The touch panel display device of claim 2, wherein
in the plurality of strip-shaped members of the adhesive means, an end of one of the adjoining members is formed as a male end, and an end of the other member is formed as a female end, and
the male end of the strip-shaped member is positioned so as to be fitted into the female end of the strip-shaped member, thereby forming the gap having the multiple ones of the bent portion.

4. The touch panel display device of claim 1, wherein
the gap having the bent portion is provided between every adjoining ones of the strip-shaped members.

5. The touch panel display device of claim 1, wherein
the adhesive means is a double-sided tape.

6. A method for manufacturing a touch panel display device, comprising the steps of:
preparing a display device and a touch panel;
providing adhesive means, which is formed by a plurality of strip-shaped members, between the display device and the touch panel so as to extend along peripheries thereof, and so that at least a pair of adjoining ones of the members are arranged with a gap being interposed therebetween, where the gap has a bent portion; and
bonding the display device and the touch panel together by the adhesive means.
